(19) United States
(12) Patent Application Publication
(10) Pub. No.: US 2013/0107241 A1
(43) Pub. Date: May 2, 2013

(54) LITHOGRAPHIC APPARATUS AND SUBSTRATE HANDLING METHOD

(71) Applicants: Raymond Wilhelmus Louis LAFARRE, Helmond (NL); Hubert Marie Segers, 's-Hertogenbosch (NL); Theodorus Petrus Maria Cadee, Asten (NL); Yang-Shan Huang, Veldhoven (NL); Christiaan Louis Valentin, Eindhoven (NL)

(72) Inventors: Raymond Wilhelmus Louis LAFARRE, Helmond (NL); Hubert Marie Segers, 's-Hertogenbosch (NL); Theodorus Petrus Maria Cadee, Asten (NL); Yang-Shan Huang, Veldhoven (NL); Christiaan Louis Valentin, Eindhoven (NL)

(73) Assignee: ASML NETHERLANDS B.V., Veldhoven (NL)

(21) Appl. No.: 13/659,751

(22) Filed: Oct. 24, 2012

Related U.S. Application Data
(60) Provisional application No. 61/552,261, filed on Oct. 27, 2011.

(51) Int. Cl. G03B 27/60

(52) U.S. Cl. CPC G03B 27/60
USPC 355/73

(57) ABSTRACT

A lithographic apparatus arranged to transfer a pattern from a patterning device onto a substrate, the lithographic apparatus including a substrate table constructed to hold a substrate and a gripper arranged to position the substrate on the substrate table. The gripper includes a vacuum clamp arranged to clamp the substrate at a top side thereof. The vacuum clamp may be arranged to clamp at least part of a circumferential outer zone of the substrate top surface. There is also provided a substrate handling method including positioning the substrate using a gripper on a substrate table of a lithographic apparatus, the method including clamping the substrate at a top side thereof using a vacuum clamp of the gripper.

### CROSS REFERENCE TO RELATED APPLICATIONS

This application claims priority and benefit under 35 U.S.C. §119(e) to U.S. Provisional Patent Application Ser. No. 61/552,261, entitled “Lithographic Apparatus and Substrate Handling Method,” filed on Oct. 27, 2011, the content of which is incorporated herein in its entirety by reference.

### FIELD

The present invention relates to a lithographic apparatus, a substrate handling method and a substrate handler.

### BACKGROUND

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

Current wafer handler systems transport a substrate (e.g. a wafer) into a substrate table compartment (e.g. a wafer stage compartment). The substrate is positioned by a gripper of the handler above the substrate table and pins projecting from the substrate table take over the wafer. When the gripper is retrieved the pins move down and load the wafer onto the wafer table.

When the wafer is loaded on the wafer table, stresses may be introduced in the wafer because of friction between burls of the wafer table and the wafer. These stresses may lead to wafer deformation and consequential projection errors.

### SUMMARY

It is desirable to position a substrate onto the substrate table with a low stress or an absence of stress.

According to an embodiment of the invention, there is provided a lithographic apparatus arranged to transfer a pattern from a patterning device onto a substrate, the lithographic apparatus comprising a substrate table constructed to hold a substrate and a gripper arranged to lift the substrate from the substrate table, the gripper comprising a vacuum clamp arranged to clamp the substrate at a top side thereof.

According to another embodiment of the invention, there is provided a substrate handling method comprising positioning the substrate using a gripper on a substrate table of a lithographic apparatus, the method comprising clamping the substrate at a top side thereof using a vacuum clamp of the gripper.

According to yet another embodiment of the invention, there is provided a substrate handler for handling a substrate, the substrate handler comprising a gripper configured to grip the substrate and position the substrate on a substrate table, wherein the gripper comprises a vacuum clamp arranged to clamp the substrate at a top side thereof.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus in which an embodiment of the invention may be provided;

FIG. 2A-2C each depict a schematic, partly cross sectional side view of a part of a gripper according to embodiments of the invention;

FIGS. 3A-3B each depict a schematic, partly cross sectional side view of a part of a gripper according to embodiments of the invention;

FIG. 4 depicts a schematic, partly cross sectional side view of a part of a gripper according to an embodiment of the invention;

FIG. 5A-5B each depict a schematic, partly cross sectional side view of a part of a gripper according to embodiments of the invention;

FIG. 6A-6B each depict a schematic, partly cross sectional side view of a part of a gripper according to embodiments of the invention;

FIG. 7 depicts a schematic, partly cross sectional side view of a part of a gripper according to an embodiment of the invention;

FIG. 8A-8B each depict a schematic, partly cross sectional side view of a part of a gripper according to embodiments of the invention;

FIG. 9 depicts a schematic, partly cross sectional side view of a part of a gripper according to an embodiment of the invention;

FIG. 10A-10B depict a schematic, partly cross sectional side view respectively top view of a part of a gripper according to an embodiment of the invention;

FIG. 11 depicts a schematic, partly cross sectional side view of a part of a gripper according to an embodiment of the invention;

FIG. 12A-12B each depict a schematic, partly cross sectional side view of a part of a gripper according to embodiments of the invention; and

FIG. 13A-13B each depict a schematic, partly cross sectional side view of a part of a gripper according to embodiments of the invention.

### DETAILED DESCRIPTION

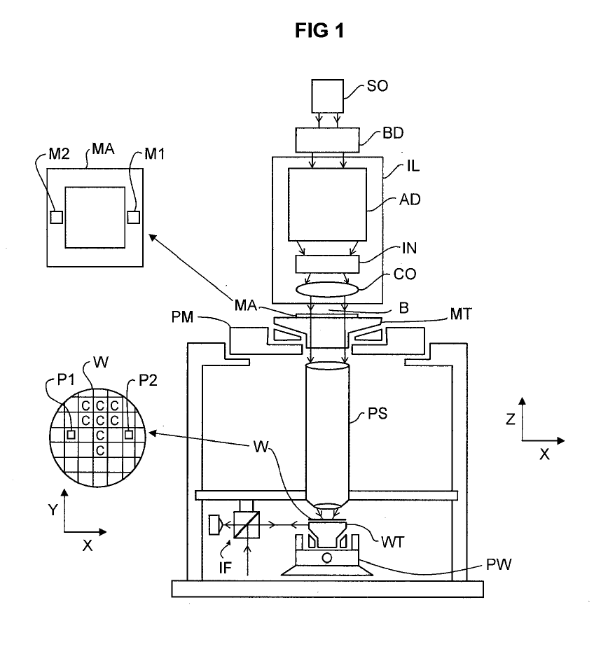

FIG. 1 schematically depicts a lithographic apparatus according to one embodiment of the invention. The apparatus includes an illumination system (illuminator) IL configured to condition a radiation beam B (e.g. UV radiation or any other suitable radiation), a support structure or patterning device support (e.g. a mask table) MT constructed to support a patterning device (e.g. a mask) MA and connected to a first positioning device PM configured to accurately position the patterning device in accordance with certain parameters. The apparatus also includes a substrate table (e.g. a wafer table) WT or “substrate support” constructed to hold a substrate (e.g. a resist-coated wafer) W and connected to a second positioning device PW configured to accurately position the substrate in accordance with certain parameters. The apparatus further includes a projection system (e.g. a refractive projection lens system) PS configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section so as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables or “substrate supports” (and/or two or more mask tables or “mask supports”). In such “multiple stage” machines the additional tables or supports may be used in parallel, or preparatory steps may be carried out on one or more tables or supports while one or more other tables or supports are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the patterning device (e.g. mask) and the projection system. Immersion techniques can be used to increase the numerical aperture of projection systems. The term “immersion” as used herein does not mean that a structure, such as a substrate, must be submerged in liquid, but rather only means that a liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device (e.g. mask) MA, the radiation beam B passes through the projection system PS, which focuses the beam onto a target portion C of the substrate W. With the aid of the second positioning device PW and position sensor IF (e.g. an interferometric device, linear encoder or capacitive sensor), the substrate table WT can be moved accurately, e.g. so as to position different target portions C in the path of the radiation beam B. Similarly, the first positioning device PM and another position sensor (which is not explicitly depicted in FIG. 1) can be used to accurately position the patterning device (e.g. mask) MA with respect to the path of the radiation beam B, e.g. after mechanical retrieval from a mask library, or during a scan. In general, movement of the support structure (e.g. mask table) MT may be realized with the aid of a long-stroke module (coarse positioning) and a short-stroke module (fine positioning), which form part of the first positioning device PM. Similarly, movement of the substrate table WT or “substrate support” may be realized using a long-stroke module and a short-stroke module, which form part of the second positioner PW. In the case of a stepper (as opposed to a scanner) the mask table MT may be connected to a short-stroke actuator only, or may be fixed. Patterning device (e.g. mask) MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device (e.g. mask) MA, the patterning device alignment marks may be located between the dies.

The depicted apparatus could be used in at least one of the following modes:

1. In step mode, the support structure (e.g. mask table) MT or “mask support” and the substrate table WT or “substrate support” are kept essentially stationary, while an entire pattern imparted to the radiation beam is projected onto a target portion C at one time (i.e. a single static exposure). The substrate table WT or “substrate support” is then shifted in the X and/or Y direction so that a different target portion C can be exposed. In step mode, the maximum size of the exposure field limits the size of the target portion C imaged in a single static exposure.
2. In scan mode, the support structure (e.g. mask table) MT or “mask support” and the substrate table WT or “substrate support” are scanned synchronously while a pattern imparted to the radiation beam is projected onto a target portion C (i.e. a single dynamic exposure). The velocity and direction of the substrate table WT or “substrate support” relative to the support structure (e.g. mask table) MT or “mask support” may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.
3. In another mode, the support structure (e.g. mask table) MT or “mask support” is kept essentially stationary holding a programmable patterning device, and the substrate table WT or “substrate support” is moved or scanned while a pattern imparted to the radiation beam is projected onto a target portion C. In this mode, generally a pulsed radiation source is employed and the programmable patterning device is updated as required after each movement of the substrate table WT or “substrate support” or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

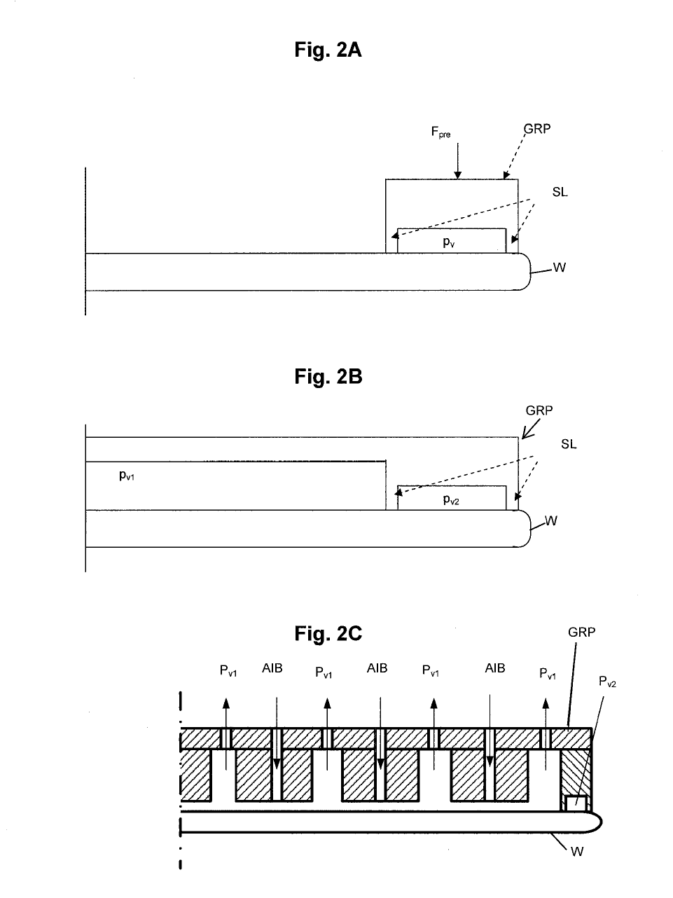

FIG. 2A-12B depict various embodiments of a part of a respective gripper body GRP arranged to grip a substrate W, such as a wafer, part of which being depicted in FIG. 2. The substrate W is gripped at a top surface thereof. Thereto, the gripper comprises a vacuum clamp which clamps the substrate at a top side thereof. As a result, conventional retractable pins that push the substrate upwards from the substrate table, so as to create a spacing between the substrate and the substrate table, the spacing to allow a gripper to grip the substrate at an underside thereof, may be avoided. Hence, the substrate table may be improved in terms of mass and rigidity. Furthermore, thermal spot effects that may occur as a result of a local contact of the pins with the substrate, may be avoided.

In an embodiment, the vacuum clamp is arranged to clamp the substrate along an outer edge thereof. By clamping (at least part of) a circumferential outer zone of the top surface of the substrate, also referred to as an exclusion area of the substrate, any effects (such as damage) on structures or patterns on the substrate may be avoided. Furthermore, as the clamp contacts a circumferential part or a segment of a circumferential part of the substrate surface, local thermal spot effects onto the substrate as a result of the heat-load from the gripper may be avoided. In case a thermal effect on the substrate occurs, its more global nature as a result of contacting the edge of the substrate, may have less effects and may more easily be compensated, for example by a suitable modeling. Still further, the substrate may be positioned on the substrate table involving little mechanical stress in the substrate. This is because clamping the substrate along the edge thereof allows to place the substrate onto the substrate table (e.g. onto burls of the substrate table) starting with a center of the substrate, due to some degree of bending of the substrate as a result of gravity force, followed by a contacting of the substrate circularly from the center towards the edge thereof, so that the substrate may be placed onto the burls with a low amount of mechanical stress. Furthermore, as the edge of the substrate, where the clamp contacts it, is commonly not supported by burls, any stresses imposed on the substrate by the clamp, may relax more freely, as the edge of the substrate is relatively free, even when positioned onto (e.g. the burls of) the substrate table.

It is noted that in this document, the term vacuum is to be understood as comprising any level of under-pressure, i.e. any pressure level below an ambient pressure as applied in a surrounding of the substrate.

FIG. 2A depicts an embodiment of a vacuum claim that is arranged to clamp along an outer edge of the substrate W. The gripper GRP comprises a vacuum chamber providing an annular vacuum onto the outer edge of the substrate W using an under-pressure pᵥ to be applied in the vacuum chamber, and concentric, annular seals SL on a radial inner and outer side of the vacuum chamber. A preload force Fₚᵣₑ may be applied onto the gripper when establishing a contact with the substrate W, so as to provide a sealing of the seals SL onto a top surface of the substrate W. One of the seals SL, e.g. the outer seal SL, may exhibit a lower stiffness in Z direction than the other seal, so as to reduce a stress in the wafer when gripped.

FIG. 2B depicts a similar gripper as depicted in FIG. 2A, however a further vacuum chamber pᵥ₁ is provided concentric with the vacuum chamber pᵥ₂ of the embodiment in accordance with FIG. 2A. When the gripper establishes a contact with the substrate W, the further (center) vacuum chamber may provide a preload so that the seals make contact with the substrate. Then, vacuum may be applied to the outer vacuum chamber pᵥ₁ and the vacuum in the center chamber pᵥ₁ may be released so as to remove the preload. The preloading may establish a good contact between the substrate surface and the seals SL, so as to avoid leakage. Also, a preload vacuum during lifting the substrate may help to lift the substrate from the substrate table. High accelerations of the gripper may be handled, as vacuum in the further vacuum chamber may increase a holding force of the gripper. Furthermore, when releasing the substrate, an overpressure may be applied to the further vacuum chamber so as to more quickly release the wafer and provide that the center of the substrate contacts the substrate table on which the substrate is to be loaded, first. Thus, when an under-pressure is applied to the further vacuum chamber before positioning the substrate on the substrate table, the under-pressure may be changed into an overpressure when positioning the substrate onto the substrate table so that the substrate shape may normalize.

FIG. 2C depicts a similar gripper as depicted in FIG. 2B, however the further vacuum chamber pᵥ₁ is provided with a plurality of air bearings for applying a local force to different parts of the substrate. Vacuum may be applied at pᵥ₁. The air bearings may keep the substrate at a distance in order to prevent that the substrate contacts the gripper when applying a vacuum in the further vacuum chamber. Thereto, pressure may be applied at AIB. A sensor or a plurality of sensors may be provided to measure a flatness of the substrate. A level of the local pressure at each of the vacuum application ducts may be adapted so as to increase flatness of the substrate. The sensor or sensors may be provided on the gripper GRP and hence measure a distance towards a top surface of the substrate. Alternatively, the sensor or sensors may be arranged to measure a distance towards a bottom surface of the substrate: in that case, the sensor or sensors may for example be provided at a stationary part of the lithographic apparatus or associated equipment, the gripper being positioned over the sensor(s) in order to measure the flatness. It is noted that the application of over-pressure and under-pressure, as described with reference to FIG. 2B, may be applied in the embodiment in accordance with FIG. 2C likewise.

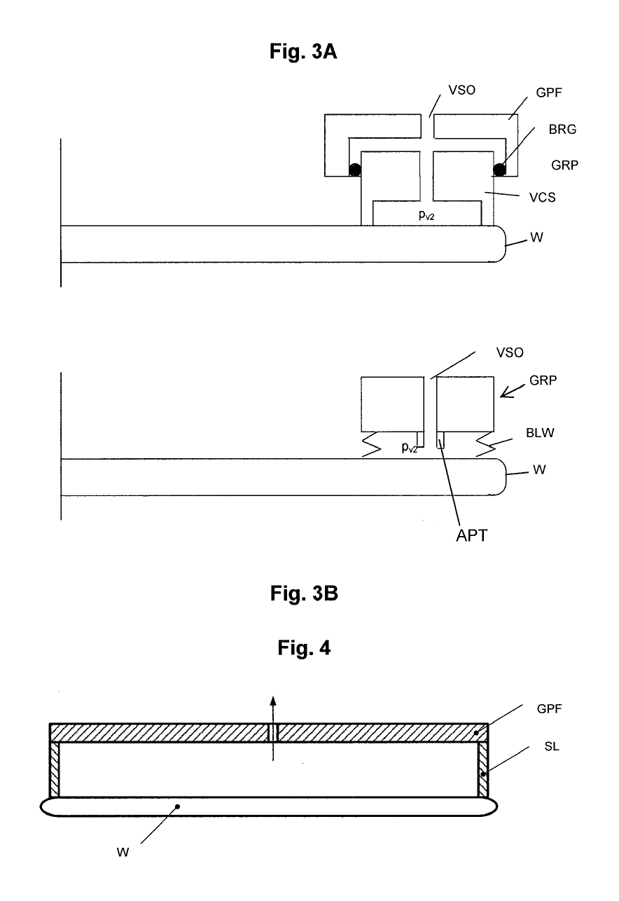

FIG. 3A depicts a similar gripper as depicted in FIG. 2A, comprising a stiff gripper frame GPF and one or more compliant vacuum clamp segments VCS that are compliant in respect of the stiff gripper frame, in this example using a bearing BRG. A vacuum supply orifice extends though the gripper frame GPF and the vacuum clamp segments VCS. The compliance allows the gripper GRP to form itself to a shape of the to be gripped substrate top surface. Due to the resilience, the substrate may be gripped even when a part of the substrate surface still has a large gap to the gripper frame. A relatively low vacuum level may suffice. A dimensioning of a vacuum contact area of the vacuum clamp segments VCS may provide for a desired clamping force: The lower a mass of the vacuum clamp segments VCS, the larger the vacuum contact area may be, in order to avoid a lifting and/or vibrating of the vacuum clamp segments on a surface of the substrate.

FIG. 3B depicts another embodiment of a compliant gripper, comprising soft seals such as in this example bellows BLW. Instead of the bellow in this embodiment, as well as in other embodiments described in this document, any other seal having a compliance in vertical direction may be applied. The gripper is provided with annular protrusions APT on either side of a vacuum supply orifice VSO. When clamped, the protrusions nearly close a supply of the vacuum to (a part of) the vacuum chamber between the soft seals (bellows BLW). A defined contact area may be provided by the protrusion.

Another embodiment of the gripper is depicted in FIG. 4, the gripper comprising a gripper frame GPF and an annular seal SL extending from the gripper frame to form a vacuum chamber. A vacuum inlet orifice may be provided for example centrally in the gripper frame GPF. The annular seal may exhibit a high stiffness in vertical direction to allow a high gripping force and an accurate positioning of the substrate in vertical direction when gripped by the gripper.

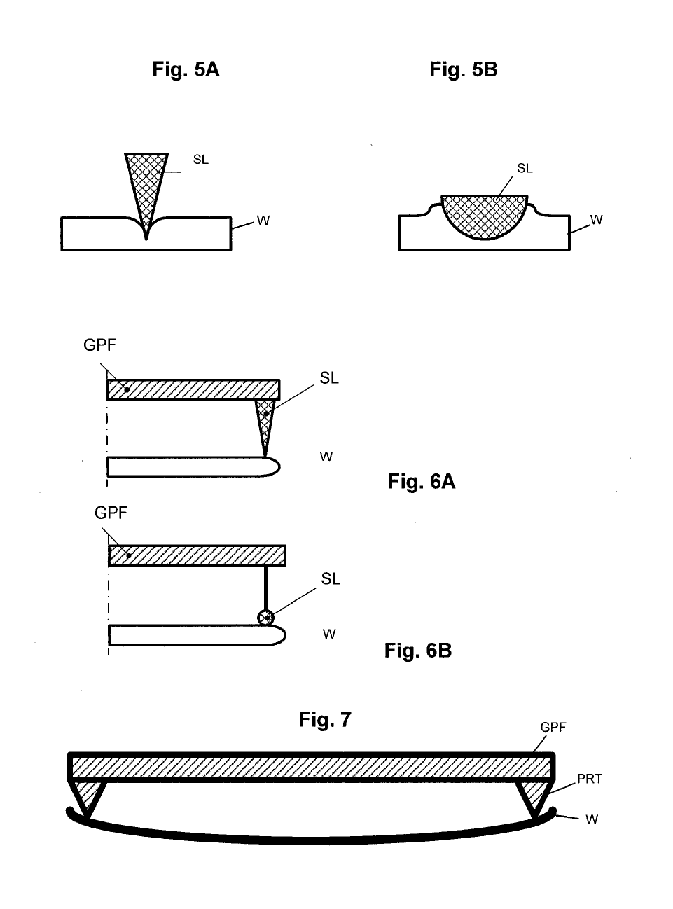

FIGS. 5A and 5B each depict a view of a part of the seal SL in contact with the surface of the substrate. As depicted in FIG. 5A, the annular seal, such as of the gripper depicted in FIG. 4, may form a ring knife, e.g. having a sharp edge. As depicted in FIG. 5B, the annular seal, such as of the gripper depicted in FIG. 4, may form a rounded edge. Both the ring knife and rounded edge aim to provide a minimum impact on the substrate (e.g. on its resist or top coat layer). Using the rounded edge, a relatively large surface contact is applied reducing a contact pressure hence reducing deformation/indentation. The ring knife contacts the substrate with a minimum surface, possibly cutting into a small zone of the resist or top coat layer of the substrate. In case of a small lateral movement between gripper and substrate, the ring knife may stay at its position, and therefore generate less particles. It is noted that a mechanical seal may be applied in order to cover a remaining groove (if any) left by the contact of the annular seal. An example of the gripper having a seal SL that forms an annular knife is depicted in FIG. 6A, while an example of the gripper having a seal SL that provides a rounded edge is depicted in FIG. 6B.

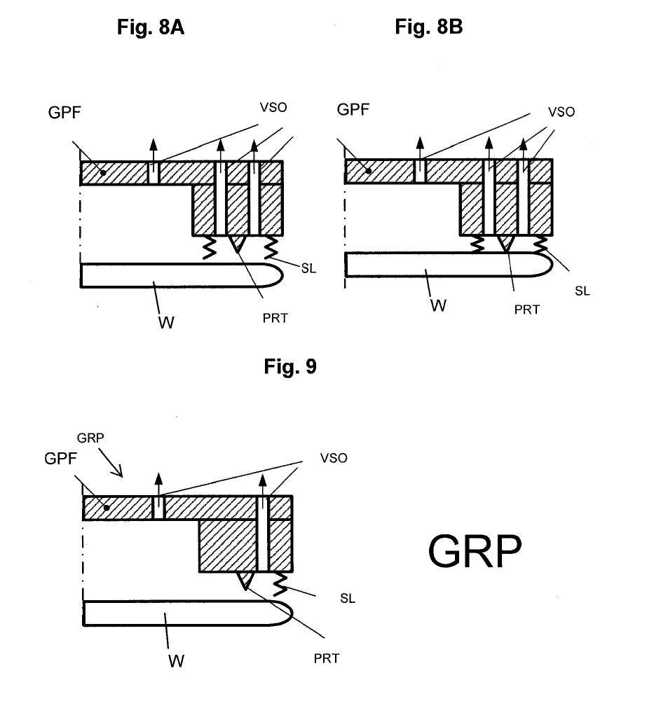

FIG. 7 highly schematically illustrates an example of a gripper having a dedicated contact structure formed by protrusion PRT, such as an annular protrusion. The dedicated contact structure may allow an accurately defined positioning of the substrate, may provide a high lateral stiffness during transportation of the substrate by the gripper. Embodiments of grippers comprising such dedicated contact are described below with reference to FIGS. 8A, 8B and 9.

FIGS. 8A and 8B depict an embodiment whereby the gripper frame GPF comprises two concentric soft seals SL and a contact structure formed by annular protrusion PRT there between. On either side of the annular protrusion, a respective vacuum supply orifice VSO leads to the vacuum chamber. As depicted in FIG. 8B, when the substrate contacts the annular protrusion as a result of the vacuum suction force, an accurately defined positioning of the substrate may be provided. It is noted that, as depicted in FIGS. 8A and 8B, a further vacuum chamber may be provided, concentric inside the vacuum chamber, the further vacuum chamber having its own vacuum supply orifice. Different levels (pressures) of vacuum may be applied via the respective vacuum supply orifices VSO, so as to introduce a bending force on the substrate. For example, the parts of the vacuum chamber on the radial inner and outer side of the protrusion PRT may be provided with different vacuum pressure levels or the vacuum supply orifices of the vacuum chamber and the vacuum supply orifice of the further vacuum chamber may be provided with different vacuum pressure levels. The concentric vacuum supply chamber may be applied similarly as described with reference to FIG. 2B.

A slightly simplified embodiment is depicted in FIG. 9. Here, the second (inside) soft seal and inside one of the vacuum supply orifices of the vacuum chamber have been omitted, so that the contact structure may act as a seal between the vacuum chamber and the further vacuum chamber concentric inside the vacuum chamber.

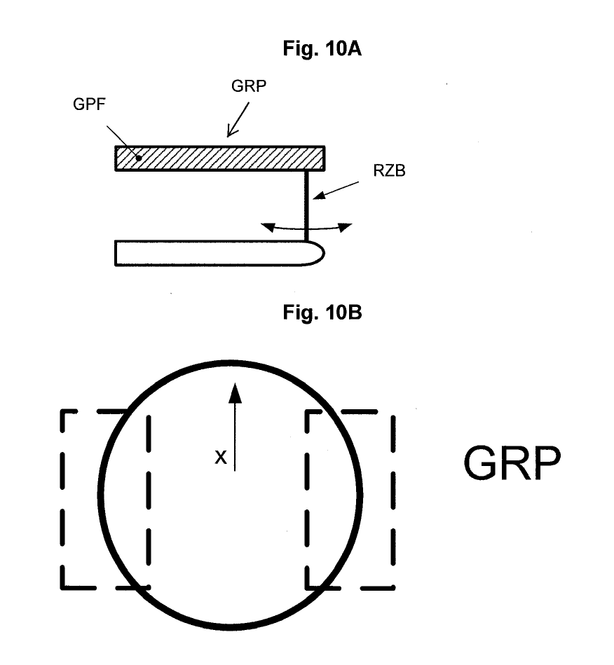

FIG. 10A depicts a highly schematic view of a gripper comprising a gripper frame GPF and an annular seal formed by a razor blade structure RZB. The vacuum chamber is sealed by the razor blade structure RZB. The razor blade structure may provide compliance in radial direction to reduce substrate deformation, while providing a high stiffness in translational direction: as depicted in a schematic top view in FIG. 10B, when translating in x direction, the area's of the razor blade identified within the area marked by the dotted lines, exhibit a high stiffness in the direction of movement. The razorblade structure may comprise an electrically conductive material which may avoid or reduce electrostatic discharges from the outer edge of the substrate that is clamped, to an inner area of the substrate surface, where patterned structures may be or are to be projected.

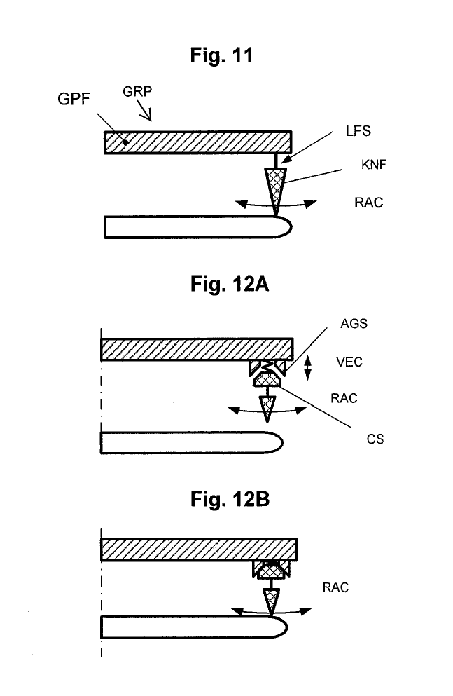

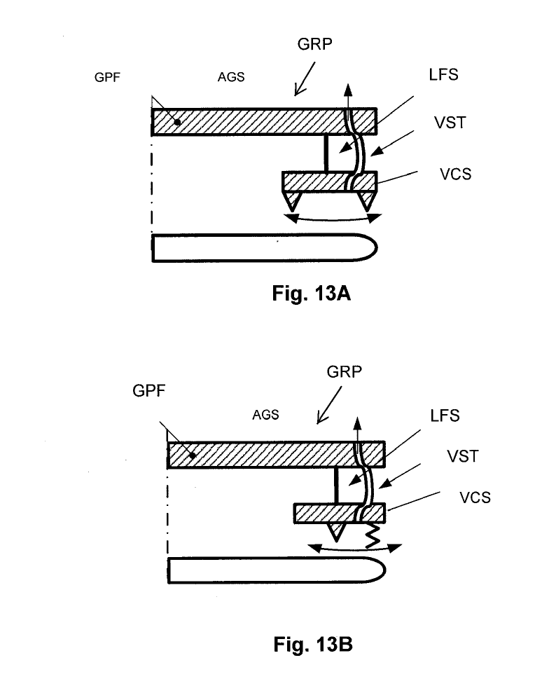

A similar effect as described with reference to FIGS. 10A and 10B, may be obtained by the embodiment depicted in FIG. 11. In this embodiment, the seal is formed by an annular knife KNF. A spring structure, such as in this example an annular leaf spring LFS interconnects the gripper body and the annular knife KNF so as to provide a radial compliance RAC of the annular knife KNF. Another embodiment of the spring structure is depicted in FIGS. 12A and 12B. In this embodiment the spring structure comprises a spring that allows a vertical compliance VEC. On or in the gripper frame GPF, an annular gutter structure AGS is formed (e.g. hemispherical), while at the side of the annular knife KNF, a complementary structure CS is formed that is complementary with the annular gutter structure (e.g. spherical), so as to allow the complementary structure to be received by the annular gutter structure. Thereby, the annular knife KNF, even when the leaf spring is compressed (as depicted in FIG. 12B), may exhibit a radial compliance RAC. A still further embodiment employing an example of the spring structure is depicted in FIG. 13A. In this embodiment, the spring structure is formed by a leaf spring LFS that connects the gripper frame GPF to a vacuum clamp subframe VCS, the vacuum clamp subframe comprising two concentric annular seals, in the embodiment in FIG. 13A, the seals are formed by annular knifes or annular protrusions, while in the embodiment depicted in FIG. 13B, one of the seals is formed by a protrusion or annular knife, while the other—in this example the outer annular seal, is formed by a bellow. In both the embodiments in FIGS. 13A and 13B, vacuum is provided to the vacuum chamber using a flexible vacuum supply tube VST. In both the embodiments in FIGS. 13A and 13B, the vacuum clamp subframe may be formed by a single, annular part, of may comprise a plurality (e.g. 4, 6 or 8) segments which may reduce a stress on the substrate.

The vacuum clamp may be applied to a top flat circumferential edge part of the substrate. The vacuum clamp may however also be applied to a curved edge part of the substrate so as to interfere as little as possible with any patterns on a more central area of the surface of the substrate.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A lithographic apparatus arranged to transfer a pattern from a patterning device onto a substrate, the lithographic apparatus comprising a substrate table constructed to hold a substrate and a gripper arranged to position the substrate on the substrate table, the gripper comprising a vacuum clamp arranged to clamp the substrate at a top side thereof.

2. The lithographic apparatus according to claim 1, wherein the vacuum clamp is arranged to clamp at least part of a circumferential outer zone of the substrate top surface.

3. The lithographic apparatus according to claim 1, wherein the vacuum clamp comprises two concentric seals and a vacuum chamber formed between the seals.

4. The lithographic apparatus according to claim 1, wherein the vacuum clamp comprises a vacuum chamber that is arranged to clamp at least part of the circumferential outer zone of the substrate top surface and a further vacuum chamber concentric with the vacuum chamber, to clamp at least a part of a center area of the substrate surface.

5. The lithographic apparatus according to claim 4, wherein the further vacuum chamber comprises a plurality of vacuum inlet ducts, the lithographic apparatus comprising a sensor to measure a flatness of the substrate and a vacuum application controller to control an application of vacuum to each of the vacuum inlet ducts in accordance with the measured flatness.

6. The lithographic apparatus according to claim 1, wherein the vacuum clamp comprises a stiff gripper frame and at least one compliant gripper part arranged to contact the substrate surface, the compliant gripper part being movable in respect of the stiff gripper frame.

7. The lithographic apparatus according to claim 1, wherein the vacuum clamp comprises two concentric soft seals, a vacuum supply orifice to supply the vacuum in a vacuum chamber formed between the soft seals, and annular protrusions in the vacuum chamber on either side of the vacuum supply orifice, the protrusions being formed to substantially cut off the vacuum supply to a remainder of the vacuum chamber when the substrate is clamped by the gripper.

8. The lithographic apparatus according to claim 1, wherein the vacuum clamp comprises a contact structure, formed in the vacuum chamber, the contact structure being arranged to establish a contact with the substrate when gripped by the gripper.

9. The lithographic apparatus according to claim 8, wherein the vacuum clamp comprises an annular soft seal to form an outer seal, the contact structure being annular and concentric with the soft annular soft seal, a vacuum supply orifice being provided into the vacuum chamber between the annular soft seal and the contact structure.

10. The lithographic apparatus according to claim 1, wherein the vacuum clamp comprises a gripper frame and an annular seal extending from the gripper frame to form a vacuum chamber.

11. The lithographic apparatus according to claim 10, wherein the annular seal comprises an annular razor blade.

12. The lithographic apparatus according to claim 10, wherein the annular seal comprises an annular knife and a spring structure to connect the annular knife to the gripper frame.

13. A substrate handling method comprising:
positioning the substrate using a gripper on a substrate table of a lithographic apparatus, the positioning comprising clamping the substrate at a top side thereof using a vacuum clamp of the gripper.

14. The substrate handling method according to claim 13, comprising clamping at least part of a circumferential outer zone of the substrate top surface.

15. A substrate handler for handling a substrate, the substrate handler comprising a gripper configured to grip the substrate and to position the substrate on a substrate table, wherein the gripper comprises a vacuum clamp arranged to clamp the substrate at a top side thereof.

16. The substrate handler according to claim 15, wherein the vacuum clamp is arranged to clamp at least part of a circumferential outer zone of the substrate top surface.
